(19) United States
(12) Patent Application Publication
(10) Pub. No.: US 2026/0350680 A1
(43) Pub. Date: Nov. 5, 2026

(54) MACHINE LEARNING MODELS FOR GENERATING SPECIFIC FEATURE EMBEDDINGS FOR ITEMS AND USERS OF AN ONLINE SYSTEM

(71) Applicant: Maplebear Inc., San Francisco, CA (US)

(72) Inventors: Naval Shah, Toronto (CA); Charles Wesley, San Diego, CA (US); Brent Scheibelhut, Toronto (CA); Mark Oberemk, Toronto (CA)

(21) Appl. No.: 19/194,693

(22) Filed: Apr. 30, 2025

(51) Int. Cl. G06Q 30/0601

(52) U.S. Cl. CPC G06Q 30/0631; G06Q 30/0641

(57) ABSTRACT

An online system utilizes machine learning models for generating a personalized user embedding related to a specific item feature, e.g., form factor information. The online system retrieves, from a database, an item embedding for each item the user interacted, where the item embedding is generated by a machine learning model and includes form factor information about a corresponding item. The online system utilizes user's data and the item embedding for each item the user interacted with to generate a user embedding for the user that is indicative of affinities of the user in relation to the form factor information. The online system uses the user embedding to identify a set of items from the database and select one or more items for presentation to the user. The online system causes a device associated with the user to display a user interface with information about the one or more items.

### BACKGROUND

Online systems allow their users to interact with items, e.g., by placing online orders for the items. Additionally, the online systems can recommend items to users. The online systems traditionally optimize recommendations for user preferences on the types of items, brands, etc., based on the similarity between the recommended items and the user's historical purchases. However, users of the online systems often have unique preferences when it comes to form factor. For example, some users may prefer buying juice in bulk quantities, irrespective of the specific fruit or flavor variations, while other users may prioritize single-serving packages ideal for children's lunches or afternoon snacks.

Traditional item embedding models focus primarily on the replaceability and similarity of items based on features such as brand and basic item type. For example, a 2 L bottle of 2% milk from one brand is deemed similar and replaceable to a 2 L bottle of 2% milk from another brand. However, these models do not account for individual user preferences related to the size, quantity, and form factor of products. In general, traditional online systems do not account for the form factor of the items in relation to individual user preferences (e.g., a user may prefer 2 L soda bottles over 6-packs), and as such this information is lost when a user interacts with an online system.

The failure to model user preferences for item form factors presents a technical challenge in building accurate recommendation systems. Without a structured representation of form factor preferences, conventional systems either ignore this dimension entirely or conflate form factor with other item characteristics, resulting in noisy input features and hence suboptimal recommendations. This lack of separation prevents the system from accurately learning and applying user preferences, particularly in domains where form factor strongly influences decisions. Moreover, it hampers the ability of the system to generalize user preferences across related but distinct products (e.g., preferring bulk packaging for beverages and single-serve packaging for snacks). Accordingly, there is a need for improved machine learning models and data representations that can independently capture form factor attributes of items and aggregate these into user-specific embeddings to enhance the technical performance of recommendation systems.

### SUMMARY

Embodiments of the present disclosure are directed to machine learning models for generating specific feature embeddings (e.g., form factor embeddings) for items and users of an online system.

In accordance with one or more aspects of the disclosure, the online system stores, in an item database of an online system, an item embedding for each item of a plurality of items in the item database, the item embedding including form factor information about each of the plurality of items. The online system further stores, in a user database of the online system, user interaction data including information about interactions of each user of a plurality of users of the online system with each of the plurality of items. The online system receives, via a network and from a device associated with a user of the plurality of users, a user signal indicating an interaction of the device associated with the user with the online system. Responsive to the user signal, the online system generates a user embedding for the user that is indicative of affinity of the user in relation to the form factor information about each item from a set of items the user interacted with. The online system generates the user embedding by retrieving, from the item database and using a portion of the user interaction data associated with the user, the item embedding for each item from the set of items; and aggregating the retrieved item embeddings for the set of items the user interacted with to generate the user embedding. The online system identifies, from the user database and based on the user embedding, a list of candidate items. The online system selects, based at least in part on the user embedding, one or more items from the list of candidate items. The online system generates, using information about the one or more items, a user interface signal. The online system sends, via the network, the user interface signal to the device associated with the user, wherein the sending the user interface signal causes the device associated with the user to display a user interface with the information about the one or more items.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example architectural flow diagram of deploying a machine learning model to generate form factor embeddings for items of an online system, in accordance with one or more embodiments.

FIG. 3B illustrates an example architectural flow diagram of deploying a machine learning model to generate form factor embeddings for users of an online system, in accordance with one or more embodiments.

FIG. 4 is a flowchart for a method of using machine learning models to generate form factor embeddings for items and users of an online system, in accordance with one or more embodiments.

### DETAILED DESCRIPTION

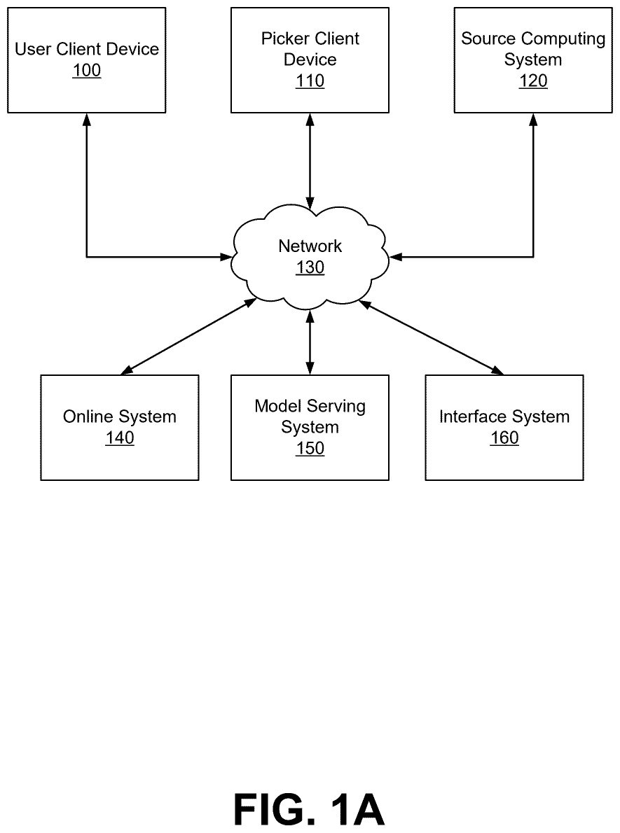

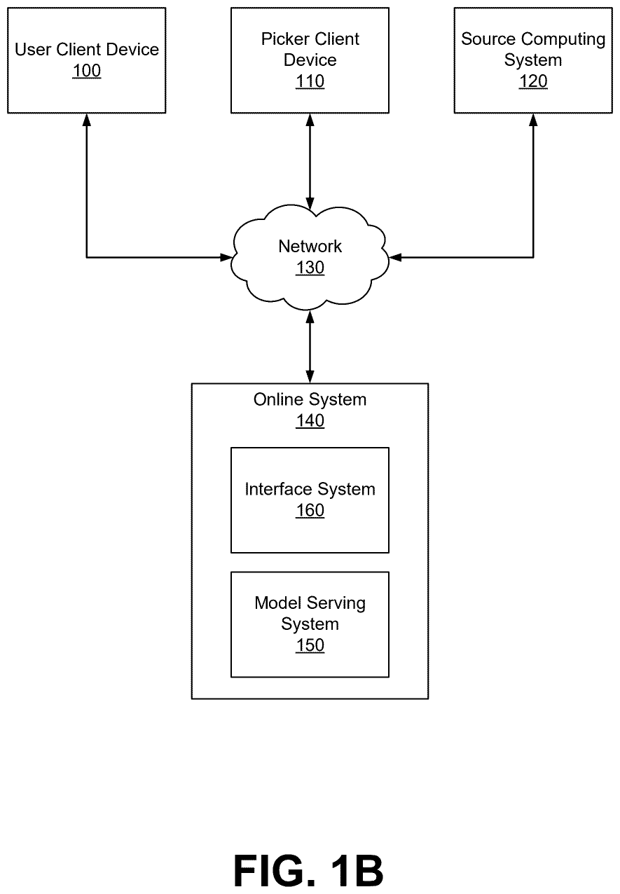

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 recommends various items to users based on the users' preferences and historical interactions (e.g., purchases). Since conventional user preferences do not separate a user's preference for a form factor of an item (e.g., 6-pack versus 2-L bottle of soda), the online system 140 trains a machine learning model to generate an embedding for the form factor of an item independently of the other item features. The machine learning model generates the form factor embedding for each item using attributes about the item related to a form factor, such as size, weight, quantity, container, packaging, etc. The machine learning model may be further supplemented by prompting a multimodal generative model (e.g., multimodal language model) with an image of the item for extracting form factor related item attributes. The online system 140 then generates an aggregated form factor embedding (i.e., a set of form factor embeddings) for a user of the online system 140 using embeddings for the items with which the user previously interacted with. The online system 140 may then utilize the aggregated form factor embedding for the user in a recommendation system to find additional items for recommendation to the user.

A form factor embedding for an item may be a vector of binary values (e.g., 0s or 1s) where each vector dimension may be a binary value associated with a respective form factor related attribute of the item. A corresponding dimension of the embedding vector may include a binary representation (e.g., encoded representation) of a corresponding form factor related attribute for the item. If the item does not possess a particular form factor related attribute, a corresponding dimension of the embedding vector may include 0 value. In one or more embodiments, the form factor embedding for the item may also include a binary representation of a taxonomy node of the item. As such, the form factor embeddings for the items are vectors in a high-dimensional latent space, where the individual dimension in the latent space have no meaning, but the relative position of the embeddings have meaning-specifically, the distance between two vectors indicates how similar the items are in relation to form factor related attributes. A set of form factor embeddings for a user of the online system 140 may represent an aggregated set of form factor embeddings for items with which the user interacted with in the past, i.e., the set of form factor embeddings for the user may represent a vector of embedding vectors.

One important purpose of utilizing embeddings is a dimensional reduction. If there is a very large number of items in an item catalog database, N, then the form factor related attributes of the items can be stored in an N×M matrix, where M is a length of an embedding vector for an individual item required to encode the form factor related attributes of the item (which can be also large). This matrix may be a relatively sparse matrix. Accordingly, as the data scales with the factor of N multiplied by the number of possible form factor related attributes of each item in the item catalog database, it makes working with non-embedding information impossible on conventional real-world computing systems. However, by converting the form factor related attributes into a single high-dimensional embedding vector for each item, the information scale linearly with N (e.g., if the number of items is doubled, the number of embeddings is only twice larger). This dimensional reduction is a solution to a technical problem of performing operations with very large datasets, such as with the items from a very large catalog that are related to a set of historical orders (e.g., stored in the data store 240).

The process flow of the online system 140 presented herein has two main components or phases. The first component is an item embedding model that is focused on “form factor” related attributes for items. For example, the item embedding model may cluster snack sized items together, or large 2 L juices together, irrespective of flavor or fruit. The second component or phase of the process flow of the online system 140 is to use outputs of the item embedding model, combined with user's signals and user's history (e.g., transactions, searches) to understand what form factor related affinity each user has. This can be then utilized in a variety of use cases, including constructing personalized item recommendations and carousels.

Hence, in the first phase of the process flow, the online system 140 deploys the item embedding model that factors in attributes related to form factor of items (e.g., item size, weight, quantity, packaging, container, etc.). This allows for understanding how the items in an item catalog database relate to one another in terms of form factor related attributes (and not in the manner of traditional ‘similarity’). The form factor can refer herein to the bundle of attributes related to size, quantity, weight, packaging, container information, etc. In the second phase of the process flow, the online system 140 applies another machine learning model that, for a given user, can determine whether they have an affinity for a particular form factor so that the online system 140 can support some of the personalized use cases as outlined below. Thus, the online system 140 presented herein allows for personalizing the user's experience and providing for a number of different cart building flows.

Users of the online system 140 often have specific preferences that span products and items. A typical example is that users may want small snack size items to put in their lunch or their children's lunches. The online system 140 presented herein allows for deduction of these preferences, and also provides the means to users to browse items that fit their form factor preference. Other use cases involve improving the replacements algorithm of the online system 140, providing consumer-packaged goods (CPG) entities and/or sources with insights about form factor related preferences for users. This may allow sources to build custom areas in aisles that all have similar form factor items (e.g., snack aisle, bulk aisles, etc.).

Users of the online system 140 may benefit by discovering items that match their specific preferences. For example, a user who prefers bulk-size juices would be presented with an assortment of such items independent of their flavors, improving satisfaction and conversion efficiency. Similarly, a user who prefers shelf stable snacks for a child's lunch would be presented with those relevant items both as custom item carousels and replacement suggestions. At the same time, sources can gain through increased sales and transaction volumes. Additionally, the insights derived from the embedding models can impact decisions on physical layout in source locations. Sources can optimize aisle arrangements by grouping similar items such as creating a dedicated snacks aisle or a section for bulk shelf-stable drinks-based on the recommendations generated by deploying the embedding models.

The model serving system 150 receives requests from the online system 140 to perform tasks using machine learning models. The tasks include, but are not limited to, natural language processing (NLP) tasks, audio processing tasks, image processing tasks, video processing tasks, and the like. In one or more embodiments, the machine learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

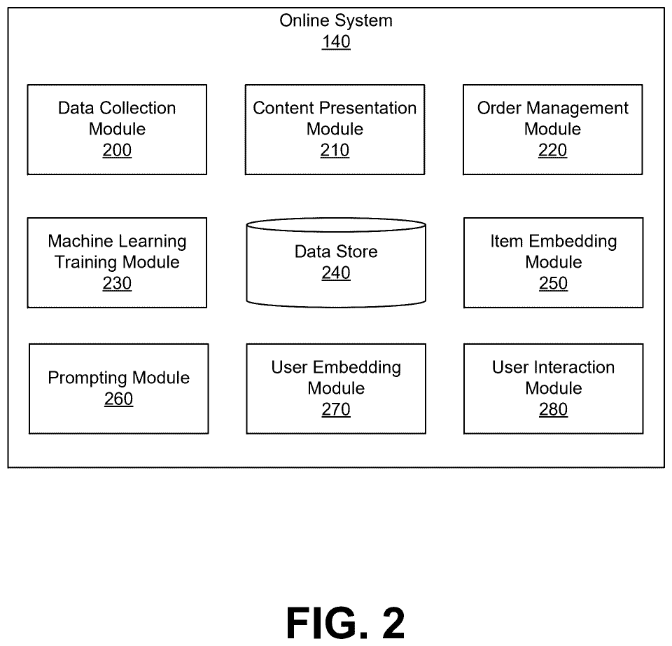

The online system 140 may prompt an LLM of the model serving system 150 (e.g., multimodal LLM) to extract from factor related attributes about an item. The online system 140 may prepare (e.g., via a prompting module 260 in FIG. 2) a prompt for input to the LLM. The prompt may include a description of the item and/or one or more images of the item (e.g., retrieved from an item catalog database of the online system 140). The LLM may generate a response to the prompt based on execution of the machine learning model using the prompt. The response may include a set of form factor related attributes about the item, such as a size, weight, quantity, container information, packaging information, shelf-stability information, etc. The online system 140 may import the response from the model serving system 150 and use the response as an input into a machine learning model to generate a form factor embedding for the item.

In one or more embodiments, the task for the model serving system 150 is based on knowledge of the online system 140 that is fed to the machine learning model of the model serving system 150, rather than relying on general knowledge encoded in the model weights of the model. Thus, one objective may be to perform various types of queries on the external data in order to perform any task that the machine learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine learning training module 230, a data store 240, an item embedding module 250, a prompting module 260, a user embedding module 270, and a user interaction module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine learning training module 230 trains machine learning models used by the online system 140. The online system 140 may use machine learning models to perform functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, transformers, large-language models, or multi-modal large language models. A machine learning model may include components relating to these different general categories of model, which may be sequenced, layered, or otherwise combined in various configurations. While the term “machine learning model” may be broadly used herein to refer to any kind of machine learning model, the term is generally limited to those types of models that are suitable for performing the described functionality. For example, certain types of machine learning models can perform a particular functionality based on the intended inputs to, and outputs from, the model, the capabilities of the system on which the machine learning model will operate, or the type and availability of training data for the model.

Each machine learning model includes a set of parameters. The set of parameters for a machine learning model are parameters that the machine learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters (e.g., the particular values of the parameters) for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, or order data. In some cases, the training examples also include a label which represents an expected output of the machine learning model. In these cases, the machine learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine learning training module 230 may apply an iterative process to train a machine learning model whereby the machine learning training module 230 updates parameter values of the machine learning model based on each of the set of training examples. The training examples may be processed together, individually, or in batches. To train a machine learning model based on a training example, the machine learning training module 230 applies the machine learning model to the input data in the training example to generate an output based on a current set of parameter values. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

In one or more embodiments, the machine learning training module 230 may retrain the machine learning model based on the actual performance of the model after the online system 140 has deployed the model to provide service to users. For example, if the machine learning model is used to predict a likelihood of an outcome of an event, the online system 140 may log the prediction and an observation of the actual outcome of the event. Alternatively, if the machine learning model is used to classify an object, the online system 140 may log the classification as well as a label indicating a correct classification of the object (e.g., following a human labeler or other inferred indication of the correct classification). After sufficient additional training data has been acquired, the machine learning training module 230 re-trains the machine learning model using the additional training data, using any of the methods described above. This deployment and re-training process may be repeated over the lifetime use for the machine learning model. This way, the machine learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine learning models hosted by the model serving system 150, the machine learning models may already be trained by a separate entity from the entity responsible for the online system 140. In one or more other embodiments, when the model serving system 150 is included in the online system 140, the machine learning training module 230 may further train parameters of the machine learning model based on data specific to the online system 140 stored in the data store 240. As an example, the machine learning training module 230 may obtain a pre-trained transformer language model and further fine tune the parameters of the transformer language model using training data stored in the data store 240. The machine learning training module 230 may provide the transformer language model to the model serving system 150 for deployment.

The item embedding module 250 may generate a form factor embedding for each item in an item catalog database (e.g., part of the data store 240) or for a preselected subset of items in the item catalog database, where the form factor embedding is indicative of form factor related attributes for that item. The item embedding module 250 may first generate a set of form factor related attributes for a given item where the set of form factor related attributes is related to a specific feature of the item (e.g., form factor). In other words, in this initial phase of the process flow, the item embedding module 250 may output a detailed list of generated attributes for a given item in the item catalog database that will be used in the subsequent phase of the process flow to generate an embedding for the item. The set of form factor related attributes for the item may include information about a size, weight, container, packaging (including multi-packs), shelf-stability, form factor, refrigeration requirement, quantity (e.g., number per package), whether the item requires preparation (cooking), whether the item is ready to be consumed without further preparation, some other form factor related information, or some combination thereof. The set of form factor related attributes may further include taxonomy information for the item, i.e., information about a taxonomy node of the item (e.g., information about a type or classification of the item).

In one or more embodiments, the item embedding module 250 generates the set of form factor related attributes for the item by directly retrieving form factor related attributes from the item catalog database. Since user preferences for form factor related attributes may vary for different types of items, the item embedding module 250 may further include information about a taxonomy node for the item into the set of form factor attributes. Additionally, or alternatively, the prompting module 260 may prompt a generative model (e.g., LLM of the model serving system 150) to generate at least some attributes in the set of form factor related attributes for the item. In such cases, the prompting module 260 may generate a prompt for input into the generative model, wherein the prompt may include a description of the item and/or one or more images of the item, e.g., as retrieved from the item catalog database by the item embedding module 250 and/or the prompting module 260 or received in real time from the user client device 100 or the picker client device 110 via the network 130. Hence, the generative model may be configured as a multimodal generative model that receives both text inputs and image data inputs. The prompting module 260 may request the generative model to extract one or more form factor related attributes for the item from the description of the item and/or the one or more images of the item. The item embedding module 250 may then import (e.g., from the model serving system 150) the one or more form factor related attributes extracted by the generative model.

In the next phase of the process flow, the item embedding module 250 may use the set of form factor related attributes to generate a form factor embedding for the item. The item embedding module 250 may access an item embedding model (e.g., machine learning model) that is trained to generate the form factor embedding for the item. The item embedding module 250 may deploy the item embedding model to run a machine learning algorithm to the set of form factor attributes generated in the first phase to output the form factor embedding for the item. A set of parameters for the item embedding model may be stored at one or more non-transitory computer-readable media of the item embedding module 250. Alternatively, the set of parameters for the item embedding model may be stored at one or more non-transitory computer-readable media of the data store 240. The item embedding module 250 may store a form factor embedding for each item generated by the item embedding model into the item catalog database.

The machine learning training module 230 may train the item embedding model to generate a form factor embedding for an item that can be used to measure similarity between items not based on traditional parameters (e.g., taxonomy related parameters) but only considering form factor related parameters, e.g., a set of form factor related attributes for the item generated in the first phase. Thus, outputs of the item embedding model may be utilized to assess similarities between items in relation to their physical form factor related attributes.

In the second phase, the user embedding module 270 may determine form factor related preferences (e.g., form factor affinity) for a user of the online system 140. The user embedding module 270 may access a user embedding model (e.g., machine learning model) that is trained to generate a form factor embedding for the user that is indicative of the form factor related preferences for the user. The user embedding module 270 may deploy the user embedding model to run a machine learning algorithm to input signals to output a form factor embedding for a given user of the online system 140. A set of parameters for the user embedding model may be stored at one or more non-transitory computer-readable media of the user embedding module 270. Alternatively, the set of parameters for the user embedding model may be stored at one or more non-transitory computer-readable media of the data store 240.

In providing the input signals to the user embedding model, the user embedding module 270 may provide user's history data combined with outputs of the item embedding model. The user embedding module 270 may first retrieve, from a user catalog database (e.g., part of the data store 240), user's order history data, user's conversion history data, and/or user's search history data. Then, for each item that the user interacted with, the user embedding module 270 may retrieve, from the item catalog database, the form factor embedding for that item that was generated by the item embedding model.

When retrieving the user's order history data and/or the user's conversion history data from the user catalog database, the user embedding module 270 may retrieve all items that the user converted on and annotate, for input into the user embedding model, with data generated by the item embedding model, i.e., with form factor embeddings for the items that the user converted on. The user embedding model may then infer that the user's order/conversion is focused on one or more form factor related attributes, which may indicate a user's tendency towards one or more form factor related attributes as primary order/conversion criteria. When retrieving the user's search history data from the user catalog database, the user embedding module 270 may retrieve all items that the user searched for and annotate, for input into the user embedding model, with data generated by the item embedding model, i.e., with form factor embeddings for the items that the user searched for. The user embedding model may then infer that the user's search history is focused on one or more form factor related attributes, which may indicate a user's tendency towards one or more form factor related attributes as primary search criteria.

The user embedding module 270 may apply the aforementioned inputs to the user embedding model to generate a set of form factor embeddings for the user. Hence, an output generated by the user embedding model may be an inferred personalized form-factor affinity for the user that is represented by one or more vectors in the embedding space. The user embedding module 270 may store a set of form factor embeddings for a given user of the online system 140 in the user catalog database as user's metadata that can be utilized in various use cases of the online system 140.

In one or more embodiments, when taxonomy information is included in form factor embeddings for items the user interacted with in the past (e.g., the items the user converted on or searched for), then the user embedding model generates a set of form factor embeddings for the user using thresholding. For example, once at least a threshold number of form factor embeddings for the items are within a certain distance of each other, then the user embedding model may generate a form factor embedding for the user by computing an average of at least the threshold number of form factor embeddings for the items.

In one or more other embodiments, when the form factor embeddings for the items the user interacted with in the past are independent of taxonomy, such that a different form factor embedding is generated for each taxonomy node, then the user embedding model generates a set of form factor embeddings for the user by aggregating the form factor embeddings for each taxonomy node. For example, the user embedding model may generate the set of form factor embeddings for the user by computing a centroid form factor embedding of the form factor embeddings for the items the user interacted with in the past, as well as a variance embedding. The user embedding model may generate the centroid form factor embedding by averaging the form factor embeddings for the items the user interacted with in the past. The user embedding model may generate the variance embedding by computing a sum of square distance of each of the form factor embeddings for the items the user interacted with in the past from the centroid form factor embedding.

The machine learning training module 230 may collect user activity data in relation to items presented to a user of the online system 140 based on a set of form factor embeddings for the user generated by the user embedding model. The user activity data may include information about what items were displayed in item carousels at a user interface of the user client device 100 and information about what items the user converted on (if any) among those items that were displayed. The user activity data may be recorded at the user client device 100 and communicated, via the network 130, to the online system 140 and the machine learning training module 230. The machine learning training module 230 may then re-train the user embedding model by updating the set of parameters of the user embedding model using the user activity data. By collecting user activity data from various users of the online system 140, the user embedding model may be re-trained and continuously improved over time.

The user interaction module 280 may receive the set of form factor embeddings for the user and utilize the set of form factor embedding for recommending items to the user, e.g., in the context of search, carousel, browsing, replacements, etc. In one or more embodiments, the user interaction module 280 deploys a recommendation model (e.g., machine learning model) to run a machine learning algorithm to input signals including the set of form factor embeddings to infer a set of items for recommendation to the user. The content presentation module 210 may generate a user interface signal using the set of items for recommendation to the user. The content presentation module 210 may send, via the network 130, the user interface signal to the user client device 100 causing the user client device 100 to display a user interface with information about the set of items.

Hence, the online system 140 may utilize a set of form factor embeddings generated for a given user of the online system 140 by the user embedding model to obtain personalized item carousels based on form factors for displaying at a user interface of the user client device 100. For example, if a user of the online system 140 frequently purchases bulk-size refrigerated juices, the user would see at a user interface of the user client device 100 a carousel dedicated to similar items, enhancing their shopping experience.

In one or more embodiments, a process of creating a personalized form factor carousel can be run as a batch or offline process on a per user basis. The process may start when the user embedding module 270 retrieves a user's full order history from the user catalog database. Then, the user embedding module 270 may compile a flat list of items that the user has ordered across the user's order history. After that, the user embedding model may overlay a form factor embedding for each of the items the user has ordered to generate the set of form factor embeddings for the user. This can also be augmented with the user's search history-a less strong signal than an actual conversion, but the signal can be weighed accordingly. For example, the user's search history may correspond to queries for tangible items.

The user embedding module 270 may set a threshold (e.g., as a rules-based setting) for a distance between embedding vectors from the set of form factor embeddings that constitutes “affinity” for similar form factor items. Additionally, the user embedding module 270 may set a threshold for a minimum number of items so that in combination with the determined distance, the user embedding module 270 can infer if the user has the affinity or not for similar items in terms of form factor related attributes. If the user is above the threshold for the distance and/or the threshold for the minimum number of items, then the content presentation module 210 can create the personalized carousel for the user with a sampling (or all) of items clustered around the above point in the vector space. The content presentation module 210 may filter out items the user has already ordered during a current session. When the user accesses a marketplace and selects a source via a user interface of the user client device 100, as long as a threshold number of the items in the form factor carousel are in-stock and available, the form factor carousel can be shown to the user via the user interface of the user client device 100.

In one or more embodiments, the online system 140 presented herein can deploy the user embedding model for custom replacement suggestions and/or augmentation for a given user of the online system 140. Using a set of form factor embeddings for the user and current content of a shopping cart, the online system 140 may generate custom replacement suggestions for the user and/or augmentation of a user interface of the user client device 100 with items of a preferable form factor related attributes, as the online system 140 understands what item attributes are the most important to the user in relation to the items that are already in the shopping cart. For example, the online system 140 can start mixing in results obtained by applying the user embedding model when there is a strong indication about the user's form factor related preferences.

In one or more embodiments, the online system 140 presented herein can deploy the user embedding model for providing insights to sources and/or CPG entities, such as insights about CPG brands. For example, a CPG brand may want to know how competitors are packaging items. The online system 140 may deploy the user embedding model to provide the CPG brand insights into what form factor related attributes are out there for relevant items or what form factor related attributes are out there that the CPG brand should use to package relevant items. Additionally, the online system 140 may prompt a generative model (e.g., LLM of the model serving system 150) with sets of form factor embeddings for a collection of users of the online system 140 to infer new form factor related attributes based on user preferences and trends.

In one or more embodiments, the online system 140 presented herein can deploy the user embedding model for source tooling and insights, i.e., to provide sources with tools to explore sets of items that are closely related according to their form factor embeddings generated by the item embedding model. The sources may utilize these insights provided by the online system 140 (e.g., via insight signals communicated from the online system 140 to the source computing systems 120 via the network 130) to optimize their physical layouts at source locations. Using information in the insight signals, the sources may construct aisles that group items by form factor related attributes, creating sections for, e.g., snacks or bulk goods based on the recommendations inferred using the item embedding model and the user embedding model. This can improve navigations at source locations and item discovery for shoppers.

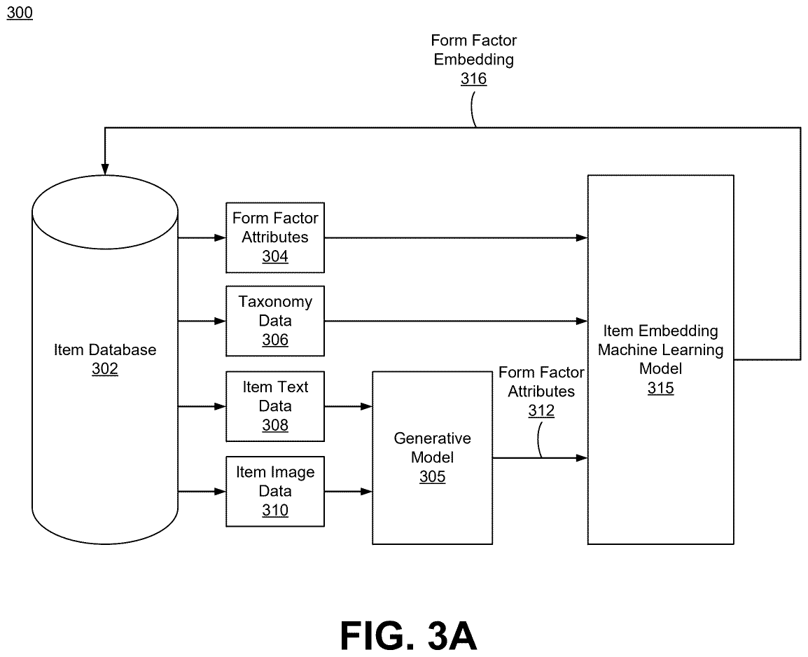

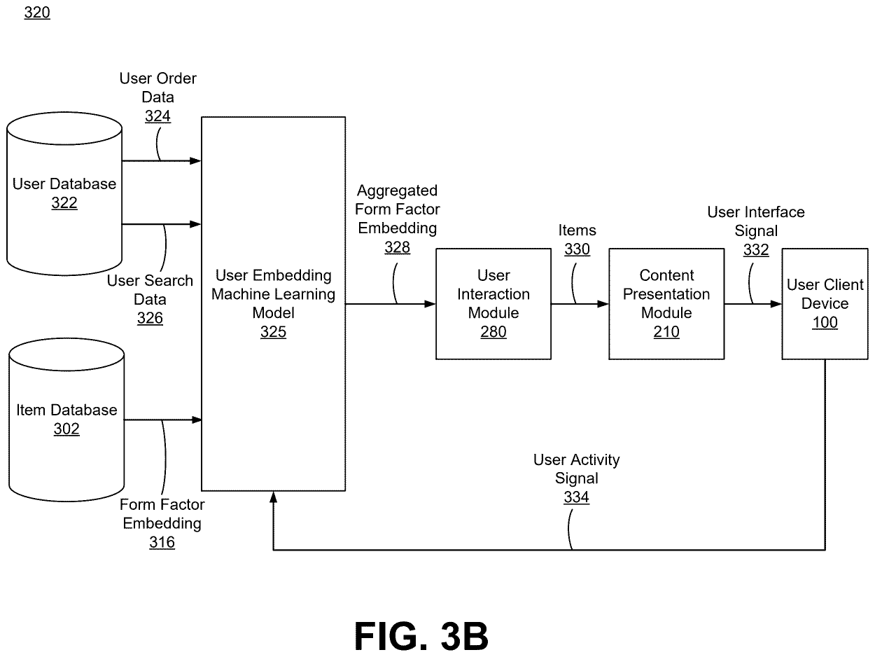

FIG. 3A illustrates an example architectural flow diagram 300 of deploying an item embedding machine learning model 315 to generate a form factor embedding for an item, in accordance with one or more embodiments. The process flow may start by the item embedding module 250 retrieving, from an item database 302 (e.g., part of the data store 240), form factor attributes 304 and taxonomy data 306 for a given item. The form factor attributes 304 may include information about a size, weight, quantity, container information, packaging information, shelf-stability information, etc. for the item. The taxonomy data 306 may include taxonomy information for the item, i.e., information related to a taxonomy node of the item, such as a type of the item or a classification of the item. The item embedding module 250 may provide the form factor attributes 304 and the taxonomy data 306 as input signals to the item embedding machine learning model 315.

Additionally, or alternatively, the item embedding module 250 may retrieve item text data 308 and/or item image data 310 from the item database 302. The item text data 308 may include a textual description of the item, and the item image data 310 may include one or more images of the item. The item embedding module 250 may pass the item text data 308 and/or the item image data 310 to the prompting module 260. The prompting module 260 may then generate a prompt for a generative model 305 (e.g., LLM of the model serving system 150) that includes the item text data 308 and/or the item image data 310. Hence, the generative model 305 may be configured as a multimodal generative model that receives text inputs and image data inputs. The prompting module 260 may request the generative model 305 to extract form factor attributes 312 for the item from the item text data 308 and/or the item image data 310. The item embedding module 250 may then import (e.g., from the model serving system 150) the form factor attributes 312 extracted by the generative model 305 and pass the form factor attributes 312 as input signals to the item embedding machine learning model 315.

The embedding machine learning model 315 may apply a machine learning algorithm to the form factor attributes 304, the taxonomy data 306, and/or the form factor attributes 312 to generate a form factor embedding 316 for the item that is indicative of form factor related attributes of the item. The embedding machine learning model 315 may then store the form factor embedding 316 into the item database 302. The aforementioned process of generating a form factor embedding for an item from the item database 302 may be repeated for each item in the item database 302 or for a defined collection of items in the item database 302.

FIG. 3B illustrates an example architectural flow diagram 320 of deploying a user embedding machine learning model 325 to generate a set of form factor embeddings for a user of the online system 140, in accordance with one or more embodiments. The process flow may start by the user embedding module 270 retrieving (e.g., in response to an interaction of the user with the online system 140 via a user interface of the user client device 100), user order data 324 and/or user search data 326 from a user database 322 (e.g., part of the data store 240). The user order data 324 may include information about items that the user ordered/converted on over a defined period of time. The user search data 326 may include information about items that the user searched for over the defined period of time. The user embedding module 270 may pass the user order data 324 and/or the user search data 326 to the user embedding machine learning model 325.

Using information (e.g., identifiers) of items in the user order data 324 and/or the user search data 326, the user embedding module 270 may retrieve, from the item database 302, a form factor embedding 316 for each item associated with the user order data 324 and/or the user search data 326, where the form factor embedding 316 for each item may be generated by the item embedding machine learning model 315 as described in relation to FIG. 3A. The user embedding module 270 may pass the form factor embedding 316 for each item to the user embedding machine learning model 325.

The user embedding machine learning model 325 may apply a machine learning algorithm to the user order data 324, the form factor embedding 316 for each item and optionally to the user search data 326 to generate an aggregated form factor embedding 328 (e.g., set of form factor embeddings) for the user. The aggregated form factor embedding 328 may be indicative of user's preferences for one or more form factor related attributes. In one or more embodiments, the user embedding machine learning model 325 generates the aggregated form factor embedding 328 for the user by averaging form factor embeddings 316 for items associated with the user order data 324 and/or the user search data 326 that are within a threshold distance from each other. In one or more other embodiments, the user embedding machine learning model 325 generates the aggregated form factor embedding 328 for the user by computing a centroid embedding of form factor embeddings 316 for items associated with the user order data 324 and/or the user search data 326 and a variance embedding. The user embedding machine learning model 325 may generate the variance embedding of the aggregated form factor embedding 328 by computing a sum of square distances for each of the form factor embeddings 316 from the centroid embedding. The user embedding module 270 may pass the aggregated form factor embedding 328 for the user to the user interaction module 280.

The user interaction module 280 may use the aggregated form factor embedding 328 for the user to generate a set of items 330 that feature one or more form factor related attributes preferred by the user. To generate the set of items 330, the user interaction module 280 may deploy a search engine or a replacement machine learning model to infer the set of items 330 that are preferred by the user in response to a user's search query, user's browsing an application of the online system 140, or in response to a request for replacement one or more items when the one or more items are unavailable at a source. The user interaction module 280 may provide information about the set of items 330 to the content presentation module 210.

The content presentation module 210 may generate, using the information about the set of items 330, a user interface signal 332. The content presentation module 210 may send, via the network 130, the user interface signal 332 to the user client device 100, wherein the sending the user interface signal 332 causes the user client device 100 to display a user interface with the information about the set of items 330. The user client device 100 may generate and record a user activity signal 334 with information about the user's activity in relation to the set of items displayed at the user interface of the user client device 100, such as information about conversion of any of the items 330. The online system 140 may receive (e.g., at the machine learning training module 230) the user activity signal 334 from the user client device 100 via the network 130. The machine learning training module 230 may utilize the user activity signal 334 to re-train the user embedding machine learning model 325. By utilizing user activity signals 334 provided over time by different users, the machine learning training module 230 may update the set of parameters of the user embedding machine learning model 325 and continuously improve the machine learning algorithm of the user embedding machine learning model 325.

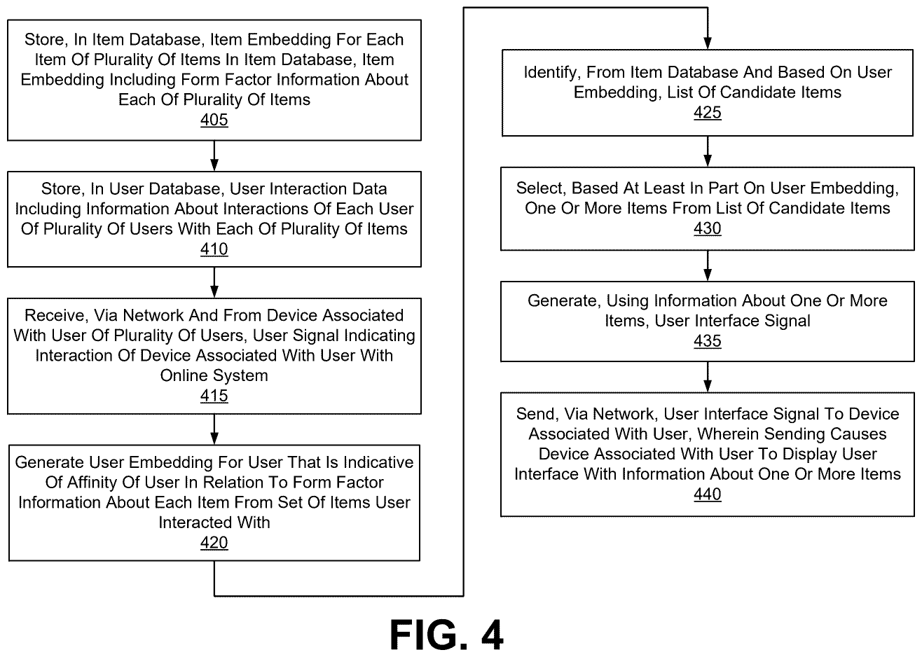

FIG. 4 is a flowchart for a method of using machine learning models to generate form factor embeddings for items and users of an online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 stores 405 (e.g., via the item embedding module 250), in an item database (e.g., part of the data store 240), an item embedding for each item of a plurality of items in the item database, the item embedding including form factor information about each of the plurality of items. The form factor information may include information about a set of attributes for each item indicative of a form factor, such as size, weight, quantity, container information, packaging information, shelf-stability information, some other form factor specific information, or some combination thereof. The online system 140 further stores 410 (e.g., via the order management module 220), in a user database (e.g., part of the data store 240), user interaction data including information about interactions of each user of a plurality of users of the online system 140 with each of the plurality of items.

The online system 140 may retrieve (e.g., via the item embedding module 250), from the item database and for each item of the plurality of items, attribute data associated with the form factor information. The online system 140 may apply an item embedding machine learning model (e.g., via the item embedding module 250) to the attribute data for each of the plurality of items to generate the item embedding for each of the plurality of items.

The online system 140 may further retrieve (e.g., via the item embedding module 250), from the item database, taxonomy data including information about classification of each of the plurality of items. In such cases, the online system 140 may apply the item embedding machine learning model (e.g., via the item embedding module 250) further to the taxonomy data to generate the item embedding for each of the plurality of items including the information about classification of each of the plurality of items.

The online system 140 may retrieve (e.g., via the item embedding module 250), from the item database and for each of the plurality of items, textual information about each of the plurality of items or one or more images of each of the plurality of items. The online system 140 may generate (e.g., via the prompting module 260) a prompt for input into a generative model (e.g., LLM of the model serving system 150), the prompt including at least one of the textual information or the one or more images. The online system 140 may request (e.g., via the prompting module 260) the generative model to generate, based on the prompt input into the generative model, a response including the form factor information about each of the plurality of items. In such cases, the online system 140 may apply the item embedding machine learning model (e.g., via the item embedding module 250) to the response including the form factor information about each of the plurality of items to generate the item embedding for each of the plurality of items.

The online system 140 receives 415 (e.g., at the order management module 220), via a network (e.g., the network 130) and from a device associated with a user of the plurality of users (e.g., the user client device 100), a user signal indicating an interaction of the device associated with the user with the online system 140. Responsive to the user signal, the online system 140 generates 420 (e.g., via the user embedding module 270) a user embedding for the user that is indicative of affinity of the user in relation to the form factor information about each item from a set of items the user interacted with.

The online system 140 may retrieve (e.g., via the item embedding module 250), from the item database and using a portion of the user interaction data associated with the user, the item embedding for each item from the set of items. The online system 140 may aggregate (e.g., via the user embedding module 270) the retrieved item embeddings for the set of items the user interacted with to generate the user embedding.

The online system 140 may identify (e.g., via the user embedding module 270) that at least a threshold number of item embeddings for items from the set of items are within a threshold distance of each other. Responsive to identifying at least the threshold number of item embeddings, the online system 140 may generate (e.g., via the user embedding module 270) the user embedding by computing an average of the item embeddings that are within the threshold distance of each other.

The online system 140 may generate (e.g., via the user embedding module 270), using the retrieved item embeddings, a centroid embedding. The online system 140 may generate (e.g., via the user embedding module 270) a variance embedding by computing a sum of square distances of each of the retrieved item embeddings from the centroid embedding. The online system 140 may combine (e.g., via the user embedding module 270) the centroid embedding and the variance embedding to generate the user embedding.

Responsive to the user signal, the online system 140 may retrieve (via the user embedding module 270), from the user database, user order data including information about the set of items that the user ordered at the online system 140 over a defined time period. The online system 140 may then apply a user embedding machine learning model (e.g., via the user embedding module 270) to the user order data and the item embedding for each item from the set of items to generate the user embedding.

Responsive to the user signal, the online system 140 may retrieve (e.g., via the user embedding module 270), from the user database, user search data including information about a second set of items that the user searched for over a defined time period. The online system 140 may then retrieve (e.g., via the user embedding module 270), from the item database, a second item embedding for each item from the second set of items, the second item embedding including form factor information about each item from the second set of items. The online system 140 may apply (e.g., via the user embedding module 270) the user embedding machine learning model further to the user search data and the second item embedding for each item from the second set of items not included in the set of items to generate the user embedding.

The online system 140 identifies 425 (e.g., via the user interaction module 280), from the item database and based on the user embedding, a list of candidate items. The online system 140 may apply (e.g., via the user interaction module 280) a machine learning model to the user embedding and information about the user to generate the list of candidate items.

The online system 140 selects 430 (e.g., via the user interaction module 280), based at least in part on the user embedding, one or more items from the list of candidate items. In one or more embodiments, the online system 140 identifies (e.g., via the user interaction module 280), based on the user embedding, one or more item embeddings for the one or more items having a distance from the user embedding within a threshold distance. Responsive to identifying the one or more item embeddings within the threshold distance from the user embedding, the online system 140 filters (e.g., via the user interaction module 280) the one or more items from the list of candidate items to select the one or more items.

In one or more other embodiments, the online system 140 generates (e.g., via the user interaction module 280), based on the user embedding and an item embedding for each item from the list of candidate items, a score for each item from the list of candidate items. The online system 140 then selects, using the score for each item from the list of candidate items, the one or more items, e.g., the one or more items having their scores above a threshold score or a predefined number of items from the list of candidate items with highest scores.

The online system 140 generates 435 (e.g., via the content presentation module 210), using information about the one or more items, a user interface signal. The online system 140 sends 440 (e.g., via the content presentation module 210), via the network, the user interface signal to the device associated with the user, wherein the sending the user interface signal causes the device associated with the user to display a user interface with the information about the one or more items.

The online system 140 may receive (e.g., at the order management module 220), via the network and from the device associated with the user, user activity data with information about an activity of the user in relation to each of the one or more items. The online system 140 may update (e.g., via the machine learning training module 230), using the user activity data, a set of parameters of the user embedding machine learning model.

Embodiments of the present disclosure are directed to the online system 140 that utilizes machine learning models to generate form factor embeddings for items and users of the online system 140. A first machine learning model may be trained to generate a form factor embedding for an item that is independent of other item attributes (e.g., features). A second machine learning model may then use form factor embeddings for various items with which a user of the online system 140 interacted in the past (as generated by the first machine learning model) to generate a set of form factor embeddings for the user that is indicative of form factor related preferences of the user. The online system 140 may utilize the set of form factor embeddings for the user for obtaining personalized recommendations for the user.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
storing, in an item database of an online system, an item embedding for each item of a plurality of items in the item database, the item embedding including form factor information about each of the plurality of items;
storing, in a user database of the online system, user interaction data including information about interactions of each user of a plurality of users of the online system with each of the plurality of items;
receiving, via a network and from a device associated with a user of the plurality of users, a user signal indicating an interaction of the device associated with the user with the online system;
responsive to the user signal, generating a user embedding for the user that is indicative of affinity of the user in relation to the form factor information about each item from a set of items the user interacted with, wherein the user embedding is generated by:
retrieving, from the item database and using a portion of the user interaction data associated with the user, the item embedding for each item from the set of items, and
aggregating the retrieved item embeddings for the set of items the user interacted with to generate the user embedding;
identifying, from the item database and based on the user embedding, a list of candidate items;
selecting, based at least in part on the user embedding, one or more items from the list of candidate items;
generating, using information about the one or more items, a user interface signal; and
sending, via the network, the user interface signal to the device associated with the user, wherein the sending the user interface signal causes the device associated with the user to display a user interface with the information about the one or more items.

2. The method of claim 1, further comprising:
retrieving, from the item database and for each item of the plurality of items, attribute data associated with the form factor information; and
applying an item embedding machine learning model to the attribute data for each of the plurality of items to generate the item embedding for each of the plurality of items.

3. The method of claim 2, further comprising:
retrieving, from the item database, taxonomy data including information about classification of each of the plurality of items,
wherein applying the item embedding machine learning model comprises applying the item embedding machine learning model further to the taxonomy data to generate the item embedding for each of the plurality of items including the information about classification of each of the plurality of items.

4. The method of claim 1, further comprising:
retrieving, from the item database and for each of the plurality of items, textual information about each of the plurality of items or one or more images of each of the plurality of items;
generating a prompt for input into a generative model, the prompt including at least one of the textual information or the one or more images;
requesting the generative model to generate, based on the prompt input into the generative model, a response including the form factor information about each of the plurality of items; and
applying an item embedding machine learning model to the response including the form factor information about each of the plurality of items to generate the item embedding for each of the plurality of items.

5. The method of claim 1, wherein aggregating the retrieved item embeddings to generate the user embedding comprises:
identifying that at least a threshold number of item embeddings for items from the set of items are within a threshold distance of each other; and
responsive to identifying at least the threshold number of item embeddings, generating the user embedding by computing an average of the item embeddings that are within the threshold distance of each other.

6. The method of claim 1, wherein aggregating the retrieved item embeddings to generate the user embedding comprises:
generating, using the retrieved item embeddings, a centroid embedding;
generating a variance embedding by computing a sum of square distances of each of the retrieved item embeddings from the centroid embedding; and
combining the centroid embedding and the variance embedding to generate the user embedding.

7. The method of claim 1, wherein aggregating the retrieved item embeddings to generate the user embedding comprises:
responsive to the user signal, retrieving, from the user database, user order data including information about the set of items that the user ordered at the online system over a defined time period; and
applying a user embedding machine learning model to the user order data and the item embedding for each item from the set of items to generate the user embedding.

8. The method of claim 7, wherein aggregating the retrieved item embeddings to generate the user embedding comprises:
responsive to the user signal, retrieving, from the user database, user search data including information about a second set of items that the user searched for over a defined time period;
retrieving, from the item database and based on the user search data, a second item embedding for each item from the second set of items, the second item embedding including form factor information about each item from the second set of items; and
applying the user embedding machine learning model further to the user search data and the second item embedding for each item from the second set of items not included in the set of items to generate the user embedding.

9. The method of claim 7, further comprising:
receiving, via the network and from the device associated with the user, user activity data with information about an activity of the user in relation to each of the one or more items; and
updating, using the user activity data, a set of parameters of the user embedding machine learning model.

10. The method of claim 1, wherein identifying the list of candidate items comprises:
applying a machine learning model to the user embedding and information about the user to generate the list of candidate items.

11. The method of claim 1, wherein selecting the one or more items comprises:
identifying, based on the user embedding, one or more item embeddings for the one or more items having a distance from the user embedding within a threshold distance; and
responsive to identifying the one or more item embeddings within the threshold distance from the user embedding, filtering the one or more items from the list of candidate items to select the one or more items.

12. The method of claim 1, wherein selecting the one or more items comprises:
generating, based on the user embedding and an item embedding for each item from the list of candidate items, a score for each item from the list of candidate items; and
selecting, using the score for each item from the list of candidate items, the one or more items.

13. A computer program product comprising a non-transitory computer readable storage medium having instructions encoded thereon that, when executed by a processor, cause the processor to perform steps comprising:
storing, in an item database of an online system, an item embedding for each item of a plurality of items in the item database, the item embedding including form factor information about each of the plurality of items;
storing, in a user database of the online system, user interaction data including information about interactions of each user of a plurality of users of the online system with each of the plurality of items;
receiving, via a network and from a device associated with a user of the plurality of users, a user signal indicating an interaction of the device associated with the user with the online system;
responsive to the user signal, generating a user embedding for the user that is indicative of affinity of the user in relation to the form factor information about each item from a set of items the user interacted with, wherein the user embedding is generated by:
retrieving, from the item database and using a portion of the user interaction data associated with the user, the item embedding for each item from the set of items, and
aggregating the retrieved item embeddings for the set of items the user interacted with to generate the user embedding;
identifying, from the item database and based on the user embedding, a list of candidate items;
selecting, based at least in part on the user embedding, one or more items from the list of candidate items;
generating, using information about the one or more items, a user interface signal; and
sending, via the network, the user interface signal to the device associated with the user, wherein the sending the user interface signal causes the device associated with the user to display a user interface with the information about the one or more items.

14. The computer program product of claim 13, wherein the instructions further cause the processor to perform steps comprising:
retrieving, from the item database and for each item of the plurality of items, attribute data associated with the form factor information; and
applying an item embedding machine learning model to the attribute data for each of the plurality of items to generate the item embedding for each of the plurality of items.

15. The computer program product of claim 13, wherein the instructions further cause the processor to perform steps comprising:
retrieving, from the item database and for each of the plurality of items, textual information about each of the plurality of items or one or more images of each of the plurality of items;
generating a prompt for input into a generative model, the prompt including at least one of the textual information or the one or more images;
requesting the generative model to generate, based on the prompt input into the generative model, a response including the form factor information about each of the plurality of items; and
applying an item embedding machine learning model to the response including the form factor information about each of the plurality of items to generate the item embedding for each of the plurality of items.

16. The computer program product of claim 13, wherein the instructions further cause the processor to perform steps comprising:
identifying that at least a threshold number of item embeddings for items from the set of items are within a threshold distance of each other; and
responsive to identifying at least the threshold number of item embeddings, generating the user embedding by computing an average of the item embeddings that are within the threshold distance of each other.

17. The computer program product of claim 13, wherein the instructions further cause the processor to perform steps comprising:
generating, using the retrieved item embeddings, a centroid embedding;
generating a variance embedding by computing a sum of square distances of each of the retrieved item embeddings from the centroid embedding; and
combining the centroid embedding and the variance embedding to generate the user embedding.

18. The computer program product of claim 13, wherein the instructions further cause the processor to perform steps comprising:
responsive to the user signal, retrieving, from the user database, user order data including information about the set of items that the user ordered at the online system over a defined time period; and
applying a user embedding machine learning model to the user order data and the item embedding for each item from the set of items to generate the user embedding.

19. The computer program product of claim 13, wherein the instructions further cause the processor to perform steps comprising:
identifying, based on the user embedding, one or more item embeddings for the one or more items having a distance from the user embedding within a threshold distance; and
responsive to identifying the one or more item embeddings within the threshold distance from the user embedding, filtering the one or more items from the list of candidate items to select the one or more items.

20. A computer system comprising:
a processor; and
a non-transitory computer-readable storage medium having instructions that, when executed by the processor, cause the computer system to perform steps comprising:
storing, in an item database of an online system, an item embedding for each item of a plurality of items in the item database, the item embedding including form factor information about each of the plurality of items;
storing, in a user database of the online system, user interaction data including information about interactions of each user of a plurality of users of the online system with each of the plurality of items;
receiving, via a network and from a device associated with a user of the plurality of users, a user signal indicating an interaction of the device associated with the user with the online system;
responsive to the user signal, generating a user embedding for the user that is indicative of affinity of the user in relation to the form factor information about each item from a set of items the user interacted with, wherein the user embedding is generated by:
retrieving, from the item database and using a portion of the user interaction data associated with the user, the item embedding for each item from the set of items, and
aggregating the retrieved item embeddings for the set of items the user interacted with to generate the user embedding;
identifying, from the item database and based on the user embedding, a list of candidate items;
selecting, based at least in part on the user embedding, one or more items from the list of candidate items;
generating, using information about the one or more items, a user interface signal; and
sending, via the network, the user interface signal to the device associated with the user, wherein the sending the user interface signal causes the device associated with the user to display a user interface with the information about the one or more items.
